(19) United States
(12) Patent Application Publication
(10) Pub. No.: US 2009/0281663 A1
(43) Pub. Date: Nov. 12, 2009

(54) DEVICE AND METHOD FOR MIXING MATERIALS

(75) Inventor: Todd ROBIDA, Southbridge, MA (US)

Correspondence Address: KENYON & KENYON LLP, 1500 K STREET N.W., SUITE 700, WASHINGTON, DC, 20005, US

(73) Assignee: BOSTON SCIENTIFIC SCIMED, INC., Maple Grove, MN (US)

(21) Appl. No.: 12/435,791

(22) Filed: May 5, 2009

Related U.S. Application Data
(60) Provisional application No. 61/050,771, filed on May 6, 2008.

(51) Int. Cl. G05B 19/02; B01F 13/10; B01F 15/06; B01F 11/00; B01F 15/00

(52) U.S. Cl. 700/265; 366/343; 366/145; 366/111; 366/143

(57) ABSTRACT

A dual-axis mixing device having a rotatable main support and one or more attached offset supports such as turntables is provided. The main support and offset rotational supports can be controlled independently of one another to reduce or prevent dead zone formation in materials mixed in the centrifuge. An operator can specify various rotation procedures depending on the materials to be mixed and the operator's observation of the materials during the mixing process.

### CROSS REFERENCE TO RELATED APPLICATION

The present application claims priority to U.S. provisional application Ser. No. 61/050,771 filed May 6, 2008, the disclosure of which is incorporated herein by reference in its entirety.

### BACKGROUND

Many applications and technologies use mixtures of high-viscosity materials and solutions. For example, medical device coatings often use a polymer mixed with a solvent and various additives such as therapeutic agents. Due to the high viscosity of the polymer, achieving a uniform mixture of the desired materials may be difficult or time-consuming. Conventional mixing techniques and devices include magnetic stir plates, rolling, shaking (such as with ultrasonic tables), and paddle mixing. These techniques can be relatively slow, particularly with high-viscosity materials, often requiring processing times of a day or more. They also have a relatively high risk of material contamination, such as during loading or unloading of stir bars, mill balls, or paddles.

Recently, dual-axis centrifuges have been used to mix high-viscosity materials. These devices induce strong internal shear forces on the materials being mixed, allowing for rapid mixing of materials. Dual-axis centrifuges include devices such as the SpeedMixer™ devices available from FlackTek of Landrum, S.C. A conventional dual-axis centrifuge includes a turntable positioned on and at an angle to a carousel. A cup of material to be mixed is placed on the turntable. When the centrifuge is activated, the turntable rotates around its axis and the carousel rotates around its axis in the opposite direction of the turntable. The resulting movement causes materials in the cup to be mixed relatively quickly and thoroughly.

### BRIEF DESCRIPTION OF THE DRAWINGS

FIG. 1 shows a device having a support that is rotatable independently of the attached turntables according to an embodiment of the present invention.

FIG. 2 shows a cross-section of a cup containing a material in a configuration resulting from rotation of only a turntable in a device according to an embodiment of the present invention.

FIG. 3 shows a cross-section of a cup containing a material in a configuration resulting from rotation of only a support in a device according to an embodiment of the present invention.

FIG. 4 shows a cross-section of a cup containing a material in a configuration resulting from only simultaneous rotation of a support and an attached turntable.

FIG. 5 shows a rotation procedure for use with a device according to an embodiment of the present invention.

FIG. 6 shows a device with a user interface according to an embodiment of the invention.

FIG. 7 shows a device having multiple turntables and materials cups according to an embodiment of the present invention.

FIG. 8 shows a vision system that may be used with a mixing device and/or method according to an embodiment of the present invention.

### DETAILED DESCRIPTION

Devices according to embodiments of the invention may include a rotatable main support such as a carousel and one or more rotatable offset supports such as turntables arranged on or in the main support, where the main support and the offset support can be rotated both concurrently and independently of one another. Materials to be mixed may be placed in holders such as cups on the offset supports. By rotating only the main support or only the offset supports in addition to rotating both concurrently, the materials may be mixed more efficiently than is possible in a conventional centrifuge.

It has been found that conventional dual-axis centrifuges typically cause “dead zones” in the material being mixed. For example, when materials are mixed in a conventional dual-axis centrifuge for a time less than that required to achieve complete mixing, certain mixing areas within the mixing cup are subject to internal shear forces sufficient to cause the various materials in the cup to mix; however, a dead zone may form, typically in the center and/or bottom of the cup, where little or no mixing occurs or where mixing occurs very slowly and often due only to edge effects resulting from movement in the primary mixing regions. A dual-swirl and dead zone mixing pattern is common in dual-axis centrifuge systems. When materials of different viscosity, particle size, and/or tackiness are mixed, the dead zone may cause a buildup of unmixed material. When similar materials are mixed these effects may be less pronounced, though they may still increase the total time required to sufficiently mix the materials. For example, when a particulate material is mixed with a viscous or semi-solid material such as a polymer, the particulate material may collect in the dead zone. This buildup can prevent the materials from mixing completely, require the centrifuge to be run for an unacceptably long period of time to completely mix the materials, or require operator intervention to loosen the undesirable buildup during the mixing process.

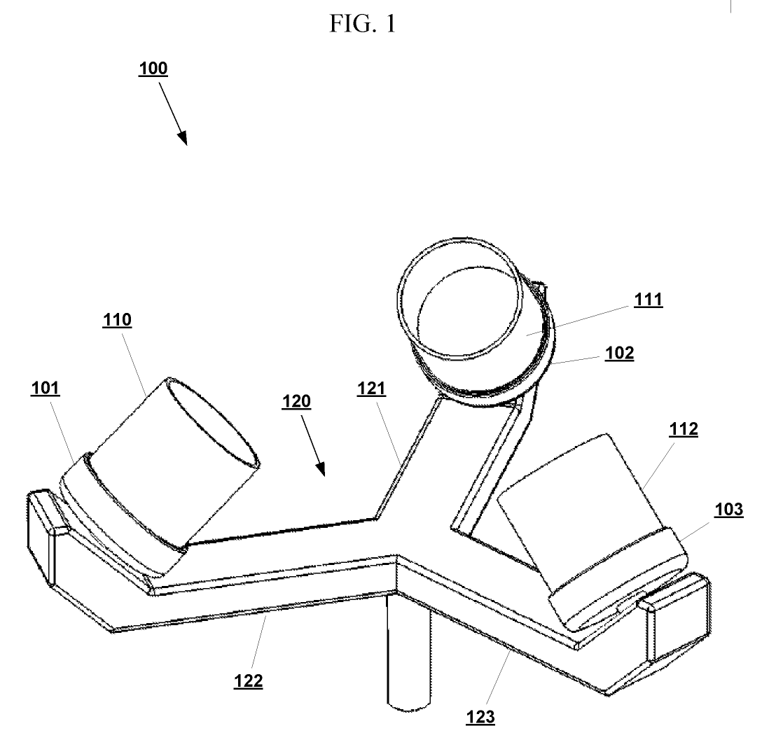

In accordance with an embodiment of the invention, the formation of dead zones in a mixture of materials may be prevented or reduced by independently varying rotation of the offset support holding the sample and the main support. FIG. 1 shows a device according to an embodiment of the present invention. The device 100 includes a rotatable main support 120 and one or more offset supports taking the form in this embodiment of turntables 101, 102, 103 attached to the main support. Each turntable may rotate independently of the main support, and may rotate in an opposite direction from the main support or in the same direction as the main support. As can be seen in FIG. 1, each offset support has an axis of rotation that is different from the axis of rotation of the main support. In the illustrated embodiment, the turntables are arranged around the axis of rotation of the main support, so that they rotate around the axis of rotation of the main support when the main support is rotated. In addition, in the illustrated embodiment, each turntable is arranged so that the axis of rotation of the turntable is at an angle with respect to the axis of rotation of the support. As an example, each turntable's axis of rotation can be tilted at an angle of about 30-60° relative to the support's axis of rotation. Holders in the form of cups 110, 111, 112 may be placed in or may be part of the turntables to contain material to be mixed. The cups may be pre-filled with the mixture materials before being placed on the turntables, or the cups may be filled while positioned on the turntables. It will be understood that the holders (e.g., the cups 110, 111, 112) may be separate from, removeably connected to, or integral with the offset supports (e.g., the turntables 101, 102, 103). The cups may be interchangeable, such that any cup may be connected to any turntable. Each turntable 101, 102, 103 may be disposed at a distance from the rotational center of the support. Typically, when multiple turntables are used each is positioned the same distance from the rotational center of the support. For example, three turntables may be disposed on arms 121, 122, 123. For devices having multiple turntables, the turntables may be arranged on the support so as to counterbalance each other. Counterweights also may be used to reduce undesirable vibration or other effects, such as for devices having a single turntable, or where varying amounts of material are placed in multiple cups.

The turntables 101, 102, 103 may be rotated independently of the main support 120. For example, the main support 120 may be driven by a separate motor than the turntables 101, 102, 103. The turntables 101, 102, 103 may be driven by a single motor or by separate motors. The turntables may be controlled together, so that each turntable is rotated at the same time and speed, or each turntable may be controlled independently. A processor or other device may control rotation of the main support and the turntables. By performing combinations of concurrent turntable and main support rotations, independent main support rotation, and/or independent turntable rotation, dead zones may be reduced or eliminated during mixing.

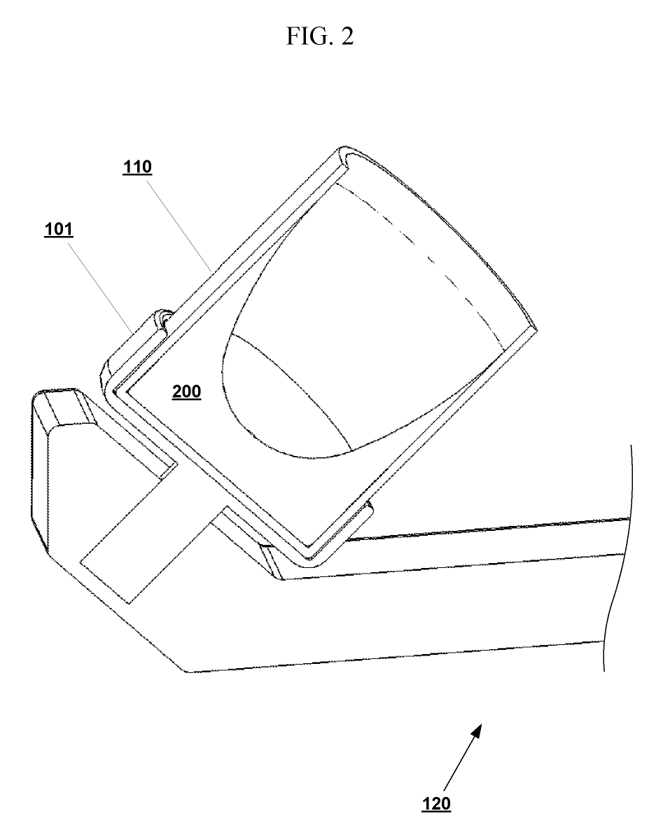

FIG. 2 shows a cross-section of a cup 110 containing a material 200 in a configuration that may result from rotation of only the turntable 101, while the main support is not rotating. The cup rotation typically will cause the material 200 to be pushed toward and up the inside surface of the cup wall.

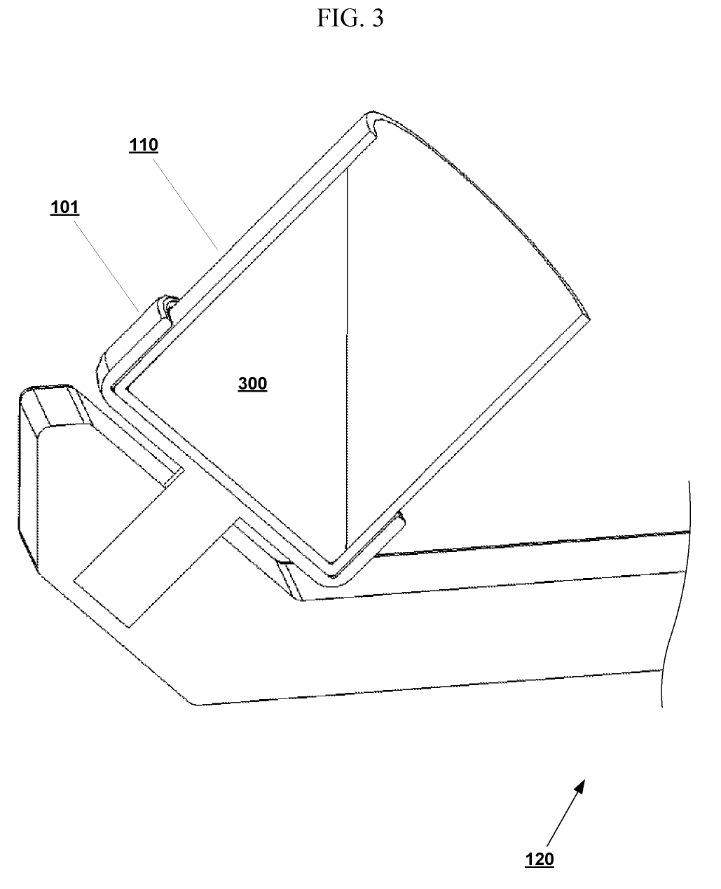

FIG. 3 shows a cross-section of a cup 110 containing a material 300 in a configuration that may result from rotation of only the main support 120, while the turntable is not rotating. The cup rotation typically will cause the material 300 to be pushed toward the outer portion of the cup relative to the center of the main support.

In each of the configurations illustrated in FIGS. 2-3, different portions of the material 200, 300 in each cup may be subjected to various different forces. For example, when only the cup is rotated as shown in FIG. 2, the material 200 may be moved away from the bottom center portion of the cup. Similarly, when only the main support is rotated as shown in FIG. 3, the material 300 may be moved away from the inner surface of the cup on those portions closer to the center of the support. Other internal shear forces may be exerted on the material in each configuration.

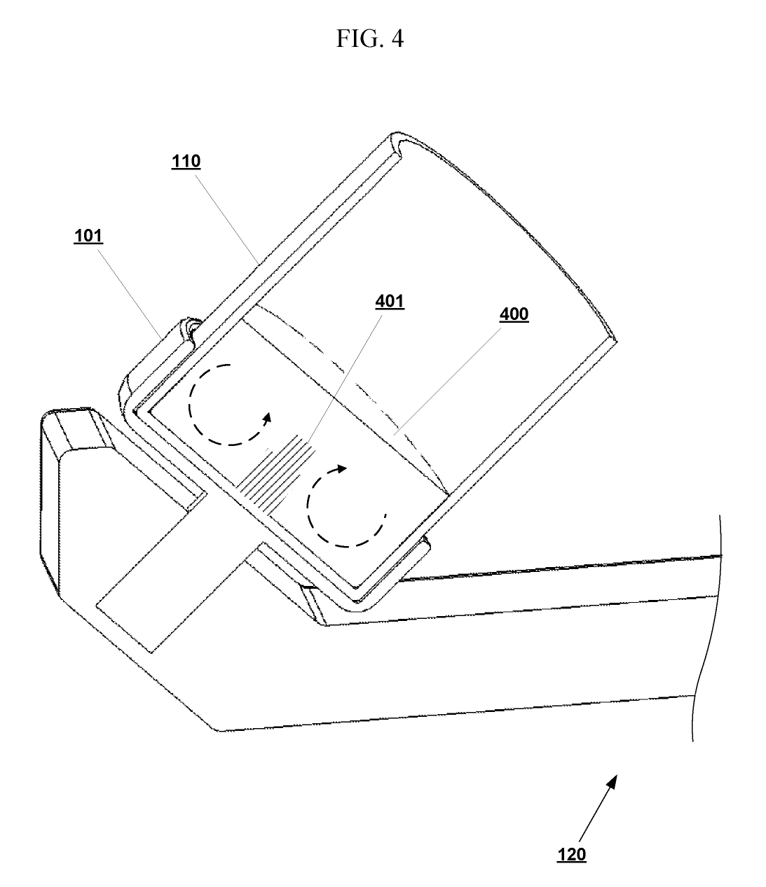

FIG. 4 shows a cross-section of a cup 110 containing a material 400 in a configuration that may result from concurrent rotation of both the support 120 and the turntable 101. The combined motion typically will cause the material 400 to collect in the lower portion of the cup. Various currents and mixing regions may be created in the material, such as those shown by the dashed arrows.

In a conventional dual-axis centrifuge, both the carousel and the turntables rotate simultaneously, which can leave a dead zone 401 where little or no mixing occurs in the bottom central portion of the material 400. To reduce or prevent formation of a dead zone, devices according to embodiments of the invention may rotate the support and turntables independently of one another. For example, a period of normal dual-axis operation (FIG. 4) may be followed by a period of support-only rotation (FIG. 3), turntable-only rotation (FIG. 2), or independent periods of each. As another example, the rotation speed of the turntable and/or the support may be varied during a dual-axis rotation or during an independent rotation. In support-only rotation modes the turntable may be held rotationally fixed, and in turntable-only rotation modes the support may be held rotationally fixed. As used herein, an object may be described as “rotationally fixed” when it is prevented from rotating about its local axis of rotation. An object that is held rotationally fixed may move in other ways and other dimensions, and may rotate about other axes of rotation. For example, when only the support is rotated (FIG. 3) and the cups are held rotationally fixed, the cups may rotate around the axis of rotation of the support. However, each cup will not rotate around its local axis of rotation. As a specific example, each cup shown in FIGS. 1-4 has a local axis of rotation along the axis of the cup cylinder. When the cup is held rotationally fixed it does not rotate around this axis, though the cup may move in other ways, such as rotating around the axis of rotation of the support.

Since each type of rotation subjects material in the mixing cup to differently-directed forces, buildup or accumulation of material in the dead zone may be reduced or removed by applying different rotation modes. As a specific example, materials to be mixed may be placed in a mixing device according to an embodiment of the present invention. The device initially may be run in a conventional dual-axis mode where both the main support and the offset support are rotated. After a certain period of time, or when an operator observes buildup or reduced mixing in a dead zone, the dual-axis rotation may be stopped and a different rotation mode engaged. In an independent rotation mode, either the main support or the offset support is rotated, while the other is held rotationally fixed. The rotation rate may be the same as during dual-axis operation or it may be different. In some embodiments, the rotation rate may be specified by an operator upon beginning the independent rotation mode. In other rotation modes, both the main support and the offset support may rotate, but the speed of one or both may be varied. By engaging different rotation modes, dead zone formation may be reduced or prevented since the different modes will exert different forces or differently-directed forces on materials mixed by the device. For example, a turntable-only rotation mode may be engaged to force materials in the mixing cups toward the outside edges of the cups, thus reducing or removing undesirable buildup in the bottom and/or center area of the cups.

When the offset supports and the main support are rotated concurrently, they typically are rotated in opposite rotational directions. Thus, the main support may rotate clockwise and the offset supports counter-clockwise, or the main support may rotate counter-clockwise and the offset supports clockwise. In embodiments where an offset support is arranged at an angle relative to the axis of rotation of the main support, the rotational direction of the offset support may be defined as if the offset support was arranged to have its axis of rotation parallel to that of the support after rotation through the smallest angle that would cause the axis of the offset support to be parallel to the axis of the main support. For example, in FIG. 1 the direction of rotation of a turntable 101 may be defined as if the turntable was arranged parallel to the arm 122, so that open end of the cup in FIG. 1 was disposed closer to the top of the device.

The offset and main supports may be controlled by a processor. The processor may be hardware or a combination of hardware and software. The processor may be configured to implement commands specifying rotation of the main and/or offset supports, concurrently or independently. The commands may be specified by an operator, such as in a rotation procedure, or may be pre-defined and stored in the device. The commands used in a rotation procedure, or commands used by the system to implement a rotation procedure or any other operation performed by the device, may be stored on a computer-readable medium. A user interface may be implemented in hardware and/or software to allow for transmission of information between the processor and an operator.

Devices according to embodiments of the invention may include additional equipment to further process materials being mixed. For example, a vibration unit such as an ultrasonic vibrator may be disposed within the device. The vibrator may be placed into contact with the main support, offset supports, and/or holders and actuated to vibrate the materials. Similarly, the device may include a shaker to agitate the main support, offset supports, and/or holders. A temperature control such as a heater and/or cooler may be controlled by the processor or operate independently to set a desired temperature within the device. Typically, the main support and offset supports may be disposed within a chamber in the device, and the temperature control arranged to measure and/or set the temperature within the chamber. An ultraviolet (UV) lamp or other radiation source may be disposed within the device. The lamp may be controlled by the processor or operate independently to irradiate materials placed in the device with UV light or other electromagnetic radiation.

In some embodiments, an operator may provide a rotation procedure to the processor that specifies various rotation modes, times, and other parameters of operation of the device. The rotation procedure may be provided directly to the device, such as via an integrated user interface, or it may be created on a separate device such as a computer and transferred to a device according to an embodiment of the invention via any suitable communication medium. Exemplary commands that may be used in a rotation procedure include: start/stop device, set speed of main support and offset support concurrently/simultaneously, set speed of main support only, set speed of offset supports only, set speed of individual offset support, set mixing time, ramp up/down main support, ramp up/down offset supports, rapid start/stop main support, rapid start/stop offset supports, set temperature, start/stop ultrasonic vibration, start/stop shaker, and turn UV lamp on/off. Other commands may be used, and commands may be used in any possible combination.

Devices according to embodiments of the invention also may have pre-configured rotation procedures. For example, when an efficient rotation procedure for specific materials is known, the rotation procedure may be stored in a mixing device according to an embodiment of the invention for use by an operator. The device may include a storage mechanism, such as a computer-readable medium, to store the rotation procedures. The device also may include a user interface as previously described to allow an operator to provide, select, modify, and remove rotation procedures stored in the device.

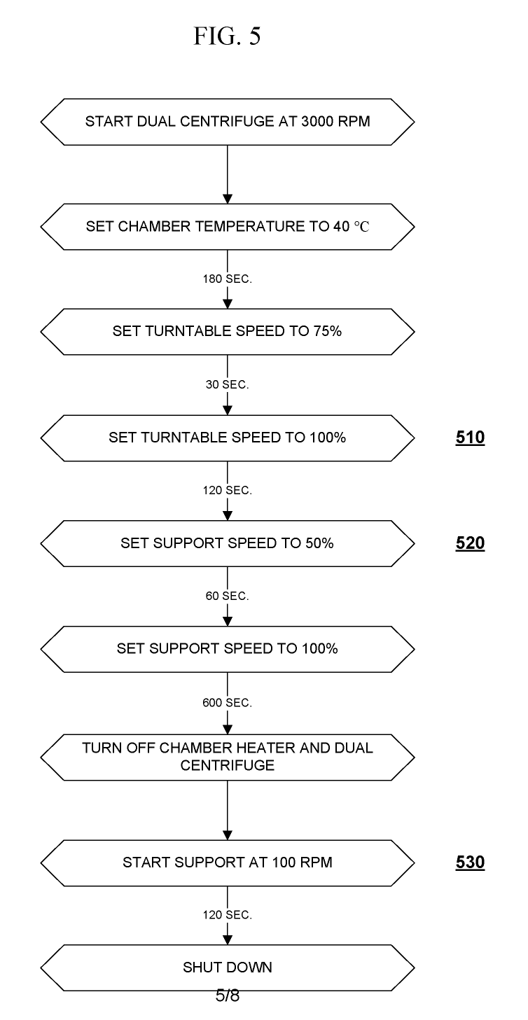

An exemplary, non-limiting rotation procedure that may be used with embodiments of the invention is shown in FIG. 5. The rotation procedure may be defined by an operator during operation of a device, or it may be predefined and stored in the device for later selection by an operator. It will be understood that the specific functions, order, and timing shown in FIG. 5 are provided as illustration only, and that other combinations, operations, and functions may be specified in a rotation procedure. Notably, rotation procedures may include commands that specify independent rotation of at least one of the turntable 510 and the support 520. Various parameters may be used to specify rotation of the turntable and/or support, such as a percentage of the maximum rotation speed 510, 520 and an absolute rotation speed 530. A rotation procedure using both dual-axis and independent rotation modes as illustrated in FIG. 5 may improve mixing of materials placed in the device. A dual-axis rotation period may provide the same mixing benefits as in a conventional dual-axis centrifuge, while independent rotation of the turntable or support rotation may prevent or reduce dead zone formation and subsequent material buildup and/or increased mixing time.

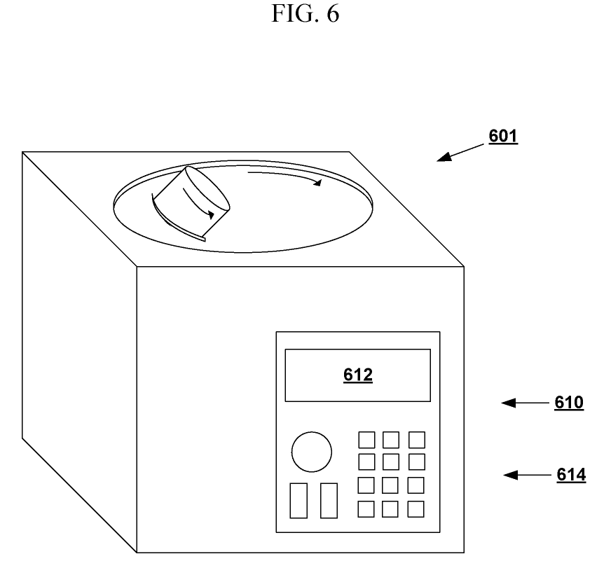

FIG. 6 shows a device with a user interface according to embodiments of the invention. The apparatus may include a mixing apparatus 601 having a rotatable support and a cup as previously described. A user interface 610 may include a display 612 and an input terminal 614. As previously described, the input terminal may be used by an operator to select or specify a rotation procedure for application by a processor controlling the mixing apparatus 601. The display 612 may provide information and options to the operator. The user interface 610 also may be implemented on or in communication with a general-purpose computer, allowing for further flexibility in communication with and configuration or programming of the device.

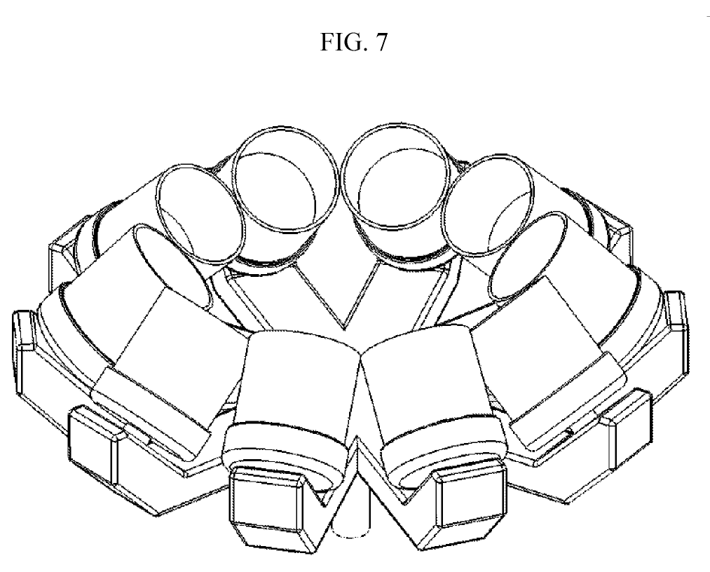

Conventional dual-axis centrifuges typically are used for research and development or prototyping purposes and, therefore, are designed to hold and mix small amounts of material. In contrast, devices according to embodiments of the invention may use multiple material cups or otherwise be configured to hold larger amounts of material. In many cases, devices according to embodiments of the invention may process a sufficient amount of material to be used in mass fabrication of materials such as for use in pharmaceuticals, medical devices, polymer coatings, therapeutic agents, polymer/therapeutic agent combinations, and other applications. In an embodiment, multiple turntables and cups may be disposed on the rotatable support as shown in FIG. 7. The turntables may be arranged on the support so as to be balanced when the same amount of material is placed in each cup. Counterweights also may be used in configurations having an unbalanced number of turntables, when not each cup is utilized, or when different materials are placed in the cups. The size and position of the cups also may be varied depending on the materials to be mixed.

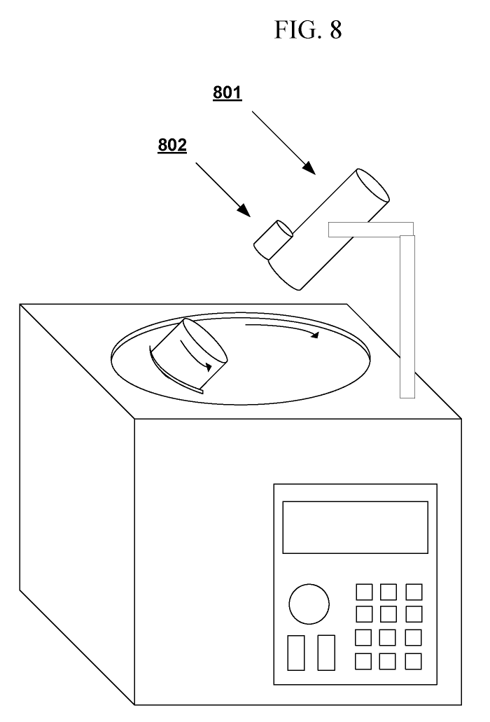

FIG. 8 shows a vision system that may be used with a mixing device and/or method according to an embodiment of the present invention. Because the device is rapidly spinning, it could otherwise be difficult to determine when the materials are sufficiently mixed. FIG. 8 shows a mechanism that can be utilized to visualize the materials being mixed during the process. FIG. 8 shows a camera 801 and a strobe 802. The camera and strobe are connected to the device such that when a cup is positioned in front of the camera, the strobe lights the material and the camera captures an image of the material. The device may have sensors to determine when the cup is properly positioned in front of the camera, and the sensors may be used to trigger operation of the strobe and camera. Alternatively, the controller of the device may be programmed to time the operation of the camera and strobe with the spinning of the device. The camera may be attached to a monitor (not shown) which can display the images from the camera to the operator for assessment of whether the materials are sufficiently mixed. To allow visualization, the cup may have a transparent lid, and/or the cup itself may be transparent. Also, it will be appreciated that a camera may be positioned to take an image from positions other than the position illustrated, such as from the side of the cup or from the bottom of the cup, and more than one camera and/or strobe may be used.

The devices and methods for mixing materials herein may be particularly suited to combining multiple materials having different viscosity, particle size, tackiness, or other similar characteristic. For example, they may be suited to fabrication of polymer and polymer/drug solutions used to coat medical devices such as stents. As a specific example, Xylene and poly(styrene-b-isobutylene-b-styrene) (SIBS) may be mixed more efficiently than with a conventional dual-axis centrifuge. For example, a solution comprising 75% Xylene and 25% SIBS may be mixed for use in roll coating of medical devices such as stents.

The various computer systems described herein may each include a storage component for storing machine-readable instructions for performing the various processes as described and illustrated. The storage component may be any type of machine readable medium (i.e., one capable of being read by a machine) such as hard drive memory, flash memory, floppy disk memory, optically-encoded memory (e.g., a compact disk, DVD-ROM, DVD±R, CD-ROM, CD±R, holographic disk), a thermomechanical memory (e.g., scanning-probe-based data-storage), or any type of machine readable (computer readable) storing medium. Each computer system may also include addressable memory (e.g., random access memory, cache memory) to store data and/or sets of instructions that may be included within, or be generated by, the machine-readable instructions when they are executed by a processor on the respective platform. The methods and systems described herein may also be implemented as machine-readable instructions stored on or embodied in any of the above-described storage mechanisms.

The devices and methods described herein may be used to fabricate or modify various therapeutic agents, such as for use in coating a medical device. The therapeutic agent may be any suitable biologically acceptable agent such as a non-genetic therapeutic agent, a biomolecule, a small molecule, or cells. Examples of therapeutic agents, as well as examples of polymers and other materials that may be mixed in a device or method according to the invention include those identified in U.S. Pat. No. 7,344,601, which is incorporated by reference herein.

Although the present invention has been described with reference to particular examples and embodiments, it is understood that the present invention is not limited to those examples and embodiments. The present invention as claimed therefore includes variations from the specific examples and embodiments described herein, as will be apparent to one of skill in the art.

What is claimed is:

1. A mixing device comprising:
a main rotatable support;
a first offset rotatable support connected to the main rotatable support, the first offset rotatable support being rotatable independently of the main rotatable support; and
a processor to control rotation of the main rotatable support and of the first offset rotatable support;
wherein the processor is configured to implement commands specifying rotation of only the main rotatable support, commands specifying rotation of only the first offset rotatable support, and commands specifying rotation of both the main rotatable support and the first offset rotatable support.

2. The mixing device of claim 1, wherein each of the main rotatable support and the offset rotatable support has an axis of rotation, and wherein the axis of rotation of the offset rotatable support is different from the axis of rotation of the main rotatable support.

3. The mixing device of claim 1, further comprising a second offset rotatable support connected to the main rotatable support, wherein the processor is configured to control rotation of the main rotatable support independently of the first and second offset rotatable supports.

4. The mixing device of claim 3, wherein the processor is configured to control rotation of each of the main rotatable support, the first offset rotatable support, and the second offset rotatable support independently of each of the others.

5. The mixing device of claim 1, further comprising an interface to receive an operator-defined rotation procedure to be implemented by the processor.

6. The mixing device of claim 1, further comprising a computer-readable medium to store a rotation procedure to be implemented by the processor.

7. The mixing device of claim 1, further comprising:
a chamber; and
a temperature control to set a temperature within the chamber;
wherein the main rotatable support and the first offset rotatable support are disposed within the chamber.

8. The mixing device of claim 1, further comprising a vibration unit physically attached to the first offset rotatable support, wherein the processor is configured to control actuation of the vibration unit.

9. The mixing device of claim 1, further comprising a shaker physically attached to the first offset rotatable support, wherein the processor is configured to control actuation of the shaker.

10. The mixing device of claim 1, further comprising an ultraviolet lamp, wherein the processor is configured to control actuation of the ultraviolet lamp.

11. The mixing device of claim 1, further comprising a camera arranged to capture an image of materials being mixed on the first offset rotatable support.

12. A mixing system comprising:
a dual-axis centrifuge comprising a main rotatable support and at least one offset rotatable support attached to the main rotatable support, the dual-axis centrifuge adapted to implement a dual-axis rotation mode in which both the main rotatable support and the at least one offset rotatable support rotate, a main support rotation mode in which the main rotatable support rotates and the offset rotatable support does not rotate, and an offset rotation mode in which the offset rotatable support rotates and the main rotatable support does not rotate;
a user interface to receive input from an operator of the dual-axis centrifuge specifying a rotation procedure;
a computer-readable medium to store the rotation procedure; and
a processor to implement the rotation procedure by engaging rotation modes specified by the rotation procedure.

13. The mixing system of claim 12, wherein the rotation procedure specifies a first time during which the dual-axis rotation mode is engaged and a second time during which one of the main rotation mode or the offset rotation mode is engaged.

14. The mixing system of claim 12, wherein the rotation procedure specifies a first time during which the dual-axis rotation mode is engaged, a second time during which the main rotation mode is engaged, and a third time during which the offset rotation mode is engaged.

15. The mixing system of claim 12, wherein the rotation procedure is defined by the operator.

16. The mixing system of claim 12, wherein the rotation procedure is predefined and the input specifying the rotation procedure comprises a selection of the predefined rotation procedure.

17. A mixing method comprising:
placing at least one material to be mixed into a rotatable holder, the rotatable holder being attached to a rotatable main support;
receiving a rotation procedure;
responsive to parameters specified by the rotation procedure, rotating one of the holder and the main support while holding the other of the holder and the main support rotationally fixed; and
responsive to parameters specified by the rotation procedure, rotating the holder and the main support concurrently.

18. The mixing method of claim 17, further comprising setting a time duration for rotating both the support and the holder.

19. The mixing method of claim 17, further comprising setting a time duration for rotating one of the holder and the main support while the other is held rotationally fixed.

20. The mixing method of claim 17, further comprising providing a rotation procedure to a processor, the processor arranged to control rotation of the main support and to control rotation of the holder.

21. The mixing method of claim 17, further comprising capturing an image of the material being mixed in the rotatable holder.

22. A computer-readable storage medium storing a plurality of instructions which, when executed by a processor, cause the processor to perform a method comprising:
rotating one of a holder holding a material to be mixed and a main support to which the holder is attached while holding the other of the holder and the main support rotationally fixed; and
rotating the holder and the main support concurrently.

23. The computer-readable medium of claim 22, the method further comprising setting a time duration for rotating both the main support and the holder.

24. The computer-readable medium of claim 22, the method further comprising setting a time duration for rotating one of the holder and the main support while the other is held rotationally fixed.

25. The computer-readable medium of claim 22, the method further comprising providing a rotation procedure to a processor, the processor arranged to control rotation of the main support and to control rotation of the holder.
